(19) United States
(12) Patent Application Publication
(10) Pub. No.: US 2017/0043288 A1
(43) Pub. Date: Feb. 16, 2017

(54) Filtered Airflow for Exercise Machines

(71) Applicant: Michael Anthony Reitz, St. Charles, MO (US)

(72) Inventor: Michael Anthony Reitz, St. Charles, MO (US)

(21) Appl. No.: 14/825,088

(22) Filed: Aug. 12, 2015

(51) Int. Cl. B01D 46/00; A63B 71/00

(52) U.S. Cl. CPC B01D 46/0041; B01D 46/0047; A63B 71/00; B01D 2273/30; B01D 2279/40

(57) ABSTRACT

The blower motor is powered by 115 volts from the circuit board that runs all of the other functions of the machine. This blower assembly is designed with enough draw to pull the incoming air across air filters in order to keep the blower and the operator free of air-borne debris. The filtered air is then supplied into the hollow framing of the equipment to be distributed to the operator, circuit boards and motors through holes made in the equipment framing. Using the machine frame as the ductwork also preserves the style and design of the equipment. Not only is this a new idea to the exercise equipment industry, but I believe it is necessary for an exercise machine to deliver clean air to the operator in order to keep their good health in mind. A blower without an air filter will send bacteria onto the user who is breathing heavy and sweating. This seems to defeat the purpose of exercising and the benefits of getting your heart rate and breathing accelerated for a length of time. The air is not mechanically cooled but typically exercise rooms are air conditioned anyhow.

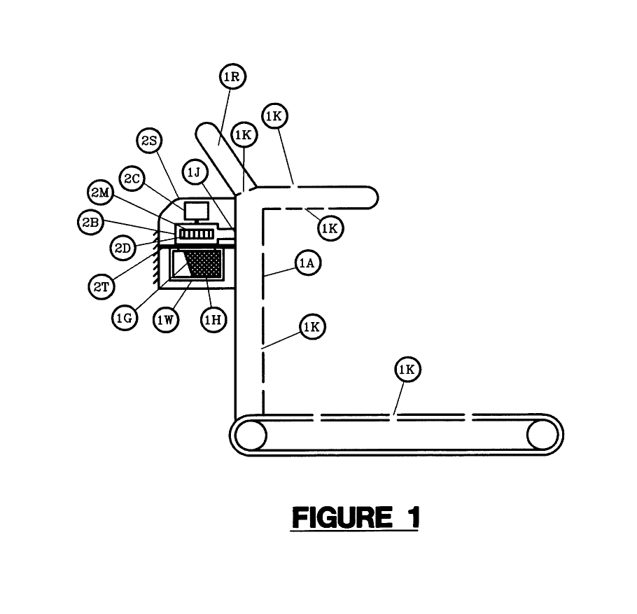

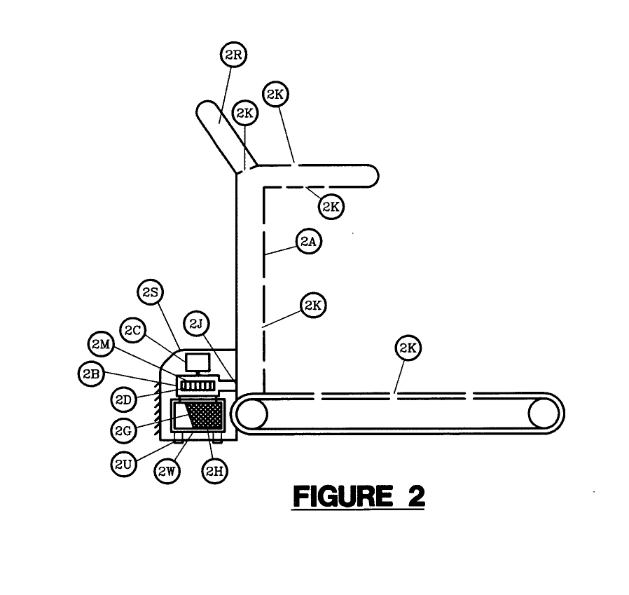

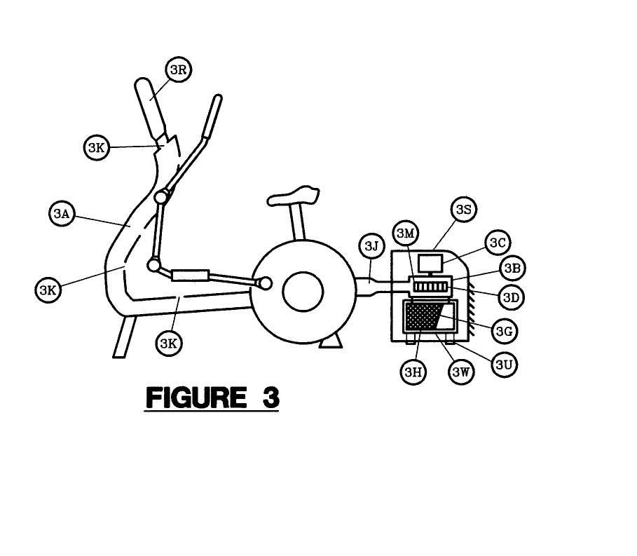

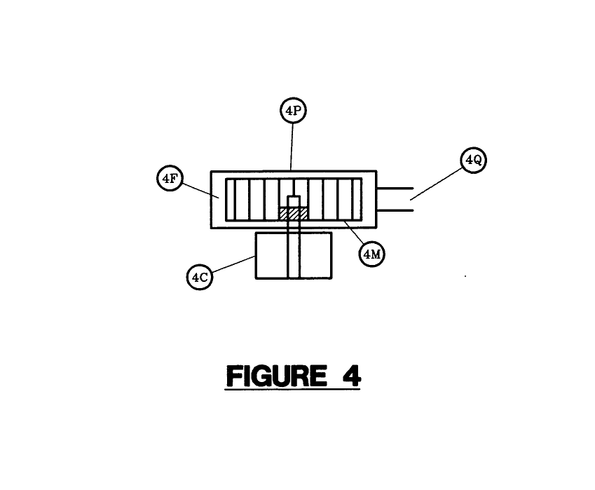

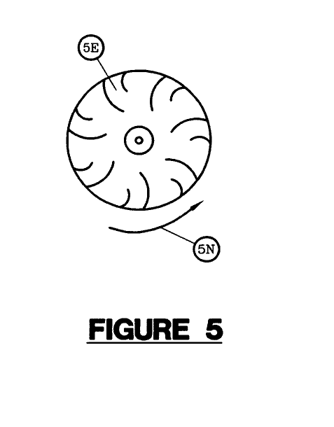

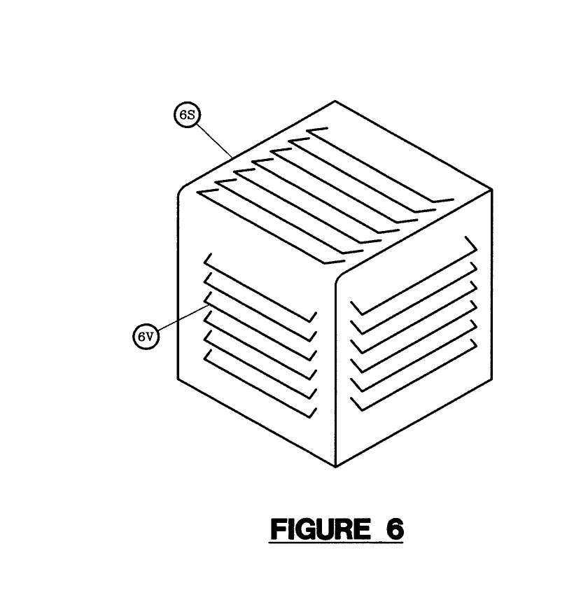

I have ideas for better ways to get things done and never knew how to protect the idea while marketing it. Last year I heard a lot of commercials on the radio about how easy it is to research and register a patent. Since then I have been working on which of my ideas had not been patented yet. I used the website to research some tools I use and moved on. I have researched this idea and it is needed. I am not going into the exercise equipment industry; I will be presenting my air flow system to the largest fitness company in the world. I know how many lawyers they have and just need something saying I came to them. My brother is their chief electrical engineer so at least I can get a meeting and I am confidant they will love what they see. Their engineers and I can work with which kind of motor and squirrel cage to use and how to design the return air box, type of louvers, and air filter, where to place it and how it is connected to the framing of the unit.

This system can be used on many different machines. The blower assembly I have built is not yet tuned for the piping diameter and length of pipe it is connected to. There is going to be some testing and tuning that will be done but it works well as it is now, so further testing will achieve even better results.

I can have this drawn on a computer aided system, however I was informed that your office prefers hand drawn pictures. You will see erased lines in most of them due to the fact that my idea kept evolving as I assembled and used it while keeping in mind the limited space available. Also, I only have a little drafting experience from high school. I can furnish a picture of the proto type, although it is only going to be used to prove to them how well it works.

### BACKGROUND

This filtered air delivery system is designed to supply filtered air into the exercise equipment framing, pressurizing the piping with air. The air being drawn into the blower assembly is drawn across air filters to remove air-borne pollutants before they are drawn into the return air box, collecting on the blower wheel, then onto the interior walls of the blower housing and inside of the equipment piping. Without air filters a blower assembly becomes clogged with debris, air flow will be restricted and contaminated air and bacteria will be expelled onto the operator. If the system is run without air filters for an extended period of time, our blower design will be easily removed and cleaned. Equipment piping can be brushed and blown out as well. Exercise equipment has a frame or skeleton that is made of hollow piping, it can be assembled to connect the various pipes so that the hollow center of these pipes form an air channel to supply air wherever it is desired. Many of the exercise machines now have only one center support pipe which makes it even easier to adapt the blower system to the existing frame. A flange will be added to the frame piping so that the blower is connected to and pushing air into the existing framing. Holes or slits placed in various locations of the pipe will direct the air all over the operator from top to bottom. Air holes can even be added to hand hold locations which is wonderful while exercising.

The blower assembly and return air filter box can be mounted to a platform along with the adapting flange for the blower housing to mount onto the frame. Louvered return air grills with internal air filter slots will make it easy to hide the blower assembly and motor inside of this enclosure while also keeping the motor windings cleaner. Only a few equipment companies have any type of air flow fans available to help cool the operator while exercising. In the summer of 2007, a new health club was built near us. My wife Jen and I signed up on Jul. 21, 2007. I started using the treadmills to train for a 5 mile run we do every year. I would always use the ones with fans to have air blowing on me while I ran. I discovered that they did not move much air or direct the air on me very well. They also do not have an air filter of any kind to remove particles from the air before blowing on the user. After the club was in business a year it was easy to see the dirt and bacteria accumulating on the blades, and the little air they did produce when they were new was now reduced as well. All these fans are doing then is just blowing contaminants onto the person using them. The problem with using fan blades to move the air is that they will not overcome the restriction of drawing the incoming air across an air filter and they do not produce any static pressure that will allow air to be pushed through piping and directed at the operator.

Now, I believe there are a few treadmill manufacturers using a typical style squirrel cage blower wheel, however, is not connected to any sort of ductwork, does not pressurize the equipment framing, and does not use any type of air filter either, so it will accumulate dust and bacteria just like the fan blades do. After the blower wheel gets impacted with debris, it to will not move much air either, motors will fail and bacteria will be blown onto the operator. Without any sort of piping or delivery system, it does not direct the air onto the user and there is no air available to cool the circuit boards or motors either.

### SUMMARY

Room temperature air, conditioned and dehumidified, is drawn across an air filter to remove dust and bacteria from the air before it enters the return air box. The filtered air is then drawn into the impeller and expelled from the pipe connection under pressure. This air is piped into the existing metal framing of the machine, pressurizing the piping so that air comes out of the holes in the framing in order to cool the operator. An air supply channel can direct supply air to the circuit boards and/or drive motors with pressurized air flowing across them in order to cool the boards and motors. As the circuit boards in the newer exercise machines are designed to perform more tasks, it will become more important to keep them cool. A supply of clean air will cool the circuit board compartment easily. Utilizing the existing air holes at the rear of the circuit board compartment to expel the warm air from the board housing after it passes over the circuit boards.

I can have this drawn on a computer aided system, however I was informed that your office prefers hand drawn pictures. You will see erased lines in most of them due to the fact that my idea kept evolving as I assembled and used it while keeping in mind the limited space available. Also, I only have a little drafting experience from high school. I can furnish a picture of the proto type. Although, the prototype is only going to be used to prove to the perspective company how well it works.

### DRAWING DESCRIPTION

Room temperature air is drawn across an air filter to remove the dust and bacteria from the air before it enters the return air box. The filtered air is then sucked into the squirrel cage and comes out of the pipe connection under pressure. This air is piped into the existing metal framing of the machine, pressurizing it so that wherever holes or slots are made, air comes out. Holes can be larger or smaller and a grid of small holes is nice for the hand hold area. An air supply channel can be created inside of the piping used to mount the control circuit board or drive motors resulting in positive pressurized and filtered air flowing across them. Air filter replacement or cleaning can be monitored with air flow sensors and maybe a switch designed to keep the blower off if the air filter is not installed at all. As circuit boards in the newer exercise machines are designed to perform more tasks, there will be a need to keep them cool. A supply of clean air will cool circuit boards and motors, using air holes on the other end of the housing to let the air out after it passes over the boards. While exercising on a machine indoors, it is nice to have air flowing over your body to help keep you cool as if you were outside jogging or riding a bike with the natural wind cooling you off. Air filters are needed because of the fact that indoor air is much dirtier than out door air and the blower wheel needs to remain clean to work well.

I have designed a device to produce more air flow and better direct the air onto a person using a piece of exercise equipment, while also adding a filter system to remove the air born debris before it gets to the blower and then onto the user. I have built a proto-type using an inducer motor assembly from a 90% efficient furnace which vents exhaust gasses through smaller p.v.c. piping rather than the inducer used for lower efficient models which vents into larger metal vent pipe. I have tested it with both clean and dirty air filters. As the filter gets dirty the air flow decreases a little, but not much. In the heating industry, inducer assemblies consist of a small blower using a squirrel cage style wheel instead of a typical prop-type fan with blades. They are used to evacuate burned gasses from heat exchangers and push the exhaust gasses out of a building through pipes. There are many types of inducers, depending on equipment design and efficiency ratings along with the style of vent piping being used. My device uses a 90% inducer that turns the blower wheel backwards from a typical squirrel cage blower. This 90% inducer wheel paddles the air instead of scooping it. This is similar to a turbo charger on a diesel truck engine, or a circulator pump for a water boiler, or a kitchen grease duct exhaust fan. I installed an inducer assembly on top of a custom made return air box and connected the return air box to the inlet side of the blower housing. An air filter is then used to cover the inlet openings into the return air box, filtering the air before it goes into the inducer assembly to be distributed into the equipment piping.

The outlet of the inducer assembly is fitted onto the existing pipe framing of the equipment. Filtered air then travels through the equipment piping and is expelled out of holes or slits along the framing, and forced onto the equipment operator.

1. The air being delivered into the exercise machine is filtered, catching debris and bacteria before it collects on the blower wheel while also preventing contaminated air from blowing onto the user. A clean blower will also maintain proper air flow. Various size holes in the pipe can be used and will not clog with debris because it will be trapped in the air filter before it gets to the air filter box and blower assembly. Air channels can be created to direct air onto circuit boards or even drive motors to keep them cooler as well. Larger holes in the pipe can be used to install a nozzle that is directional and closable; giving the user even more control over the exact location and the amount of air being directed from each nozzle. A two speed motor can be used to vary the amount of air output, giving the user a low speed and hi speed option. Air filters can be replaced as needed to ensure good air flow and filtering capability. The blower assembly proto type works well. I have included drawings with the blower mounted in various locations and on several different machines. The blower assembly is mounted to and supplies filtered air into the existing pipe framework of the machine. The prototype blower assembly has an outlet that fits into a 2″ p.v.c. pipe which is simulating the approximate diameter and length of the metal framing already being used for the equipment.

2. This air is filtered, catching debris and bacteria before it collects on the blower wheel while also preventing contaminated air from blowing onto the user. A clean blower will also maintain proper air flow. Various size holes in the pipe can be used and will not clog with debris because it will be trapped in the air filter before it gets to the air filter box and inducer assembly. Air channels can be created to direct air onto circuit boards or even drive motors to keep them cooler as well. Larger holes in the pipe can be used to install a nozzle that is directional and closable; giving the user even more control over the exact location and the amount of air being directed from each nozzle. A two speed motor can be used to vary the amount of air output, giving the user a low speed and hi speed option. Air filters can be replaced as needed to ensure good air flow and filtering capability. The inducer assembly proto type works well. I have included drawings with the blower mounted in various locations and on several different machines. The blower assembly is mounted to and supplies air into the existing pipe framework of the machine. The inducer assembly has an outlet that fits into a 2″ p.v.c. pipe which is simulating the approximate diameter and length of the metal framing already being used for the equipment.

3. The air being delivered is filtered, removing debris and bacteria before it collects on the blower wheel while also preventing contaminated air from blowing onto the user. A clean blower will also maintain proper air flow. Various size holes in the pipe can be used and will not clog, because debris will be trapped in the air filter before it gets to the air filter box and inducer assembly. Air channels in the framework will be created to direct air onto circuit boards and drive motors to keep them cooler, as well. Larger holes in the pipe can be used to install nozzles that are directional and closeable, giving the user more control over the exact location and the amount of air being directed from each nozzle. A two-speed motor provides low and high-speed options to regulate the volume of air output. Air filters are replaceable to ensure good air flow and filtering capability. The inducer assembly proto-type works well. I have included drawings with the blower mounted in various locations and on several different machines. The blower assembly is mounted to the framework and supplies air into the existing piping of the machine. The inducer assembly has an outlet that fits into a 2″ p.v.c. pipe which is simulating the approximate size and length of the metal framing used for the equipment.
